(19) United States
(12) Patent Application Publication
(10) Pub. No.: US 2024/0354405 A1
(43) Pub. Date: Oct. 24, 2024

(54) ORGANIZATIONAL MACHINE LEARNING FOR ALERT PROCESSING

(71) Applicant: VMware, Inc., Palo Alto, CA (US)

(72) Inventor: Jonathan James OLIVER, Kew (AU)

(21) Appl. No.: 18/303,491

(22) Filed: Apr. 19, 2023

(51) Int. Cl. G06F 21/55; G06N 20/00

(52) U.S. Cl. CPC G06F 21/554; G06N 20/00; G06F 2221/034

(57) ABSTRACT

A computer system comprises a machine-learning (ML) platform at which prior alerts are received from endpoints during a training period and divided into a plurality of clusters, wherein each of the clusters has an associated cluster profile that specifies expected value constraints for attributes of new alerts that are determined to belong to the cluster, and wherein the ML platform is configured to: receive a first alert and then determine that the first alert belongs to a first cluster of the clusters; compare actual values of the attributes for the first alert to respective expected value constraints for the attributes specified in the cluster profile of the first cluster; determine any deviation between the actual values of the attributes and the respective expected value constraints for the attributes; and classify the first alert into one of a plurality of alert groups based on whether there is any deviation.

### BACKGROUND

Security operations centers (SOCs) provide services for monitoring computer systems of organizations to detect threats. At SOCs, SOC analysts use various security analytics tools to evaluate security alerts. Such tools include security information and event management (SIEM) software, which includes components for automatically evaluating security alerts and components that enable manual evaluation by SOC analysts. Such tools also include correlation engines, which automatically evaluate alerts. The alerts are contextual and identify values of various attributes, such values being used for determining whether the alerts were generated in response to malicious activity or harmless activity.

The number of alerts generated by security systems is often too large to effectively monitor the computer systems. For example, the number of alerts may far outweigh the number of alerts that a team of SOC analysts can triage in a timely manner. As a result, the SOC analysts may identify malicious activity too late for remediation measures to be effective. In the case of automatic evaluators such as correlation engines, the number of alerts may be too large for the evaluators to determine malicious activity accurately.

In some cases, security systems have adapted by increasing the precision of the rules used for generating alerts. This decreases the number of alerts that are generated because not as many activities of the computer system match the rules and trigger alerts. Such increases also result in less false positives, i.e., less cases in which an alert is triggered by harmless activity. However, attackers take advantage of such changes in various ways. For example, attackers often create new malware for which the security systems have not yet incorporated precise rules for detecting. As another example, instead of using malware at all, attackers often break into computer systems and use administrative tools therein such as PowerShell® to encrypt data and blackmail and extort organizations. Such attacks, known as living off the land (LOTL) attacks, are difficult to detect with precise rules.

In other cases, instead of incorporating more precise rules, security systems have leveraged “threat scores” that are associated with the rules, e.g., values between 1 and 10. Such scores have typically been determined by security analysts who write the rules. The scores have been used to prioritize alerts, alerts that are generated in response to rules with high threat scores being evaluated before alerts that are generated in responses to rules with low threat scores. However, usage of such threat scores has been notoriously inconsistent at prioritizing alerts. Indeed, activity that is expected and likely harmless for a computer system of one organization may be unusual and likely malicious for a computer system of another organization.

Accordingly, merely reducing the coverage of alerts with highly precise rules leaves computer systems vulnerable to malicious activity. Meanwhile, traditional techniques for prioritizing alerts such as applying predetermined threat scores have proven to be ineffective for prioritizing alerts for evaluation by security analytics platforms. A method and system are needed for more effectively processing large numbers of alerts for evaluation such that malicious activity may be identified and then remediated more quickly.

### SUMMARY

One or more embodiments provide a computer system comprising a plurality of endpoints at which security agents generate alerts. The computer system further comprises a machine-learning (ML) platform at which prior alerts are received from the endpoints during a training period and divided into a plurality of clusters. Each of the clusters has an associated cluster profile that specifies expected value constraints for attributes of new alerts that are determined to belong to the cluster. The ML platform is configured to execute on a processor of a hardware platform to: receive a first alert generated by one of the security agents, and then determine that the first alert belongs to a first cluster of the clusters; compare actual values of the attributes for the first alert to respective expected value constraints for the attributes specified in the cluster profile of the first cluster; determine any deviation between the actual values of the attributes and the respective expected value constraints for the attributes; and classify the first alert into one of a plurality of alert groups based on whether there is any deviation. Alerts classified into a first alert group of the alert groups are assigned a higher priority for security risk evaluation than alerts classified into a second alert group of the alert groups.

Further embodiments include a method of processing alerts as the above ML platform is configured to perform and a non-transitory computer-readable storage medium comprising instructions that cause a computer system to carry out such a method.

### BRIEF DESCRIPTION OF THE DRAWINGS

FIG. 1 is a block diagram of a virtualized computer system in which embodiments may be implemented.

FIG. 2 is a block diagram illustrating components of a machine-learning platform of the virtualized computer system, the machine-learning platform being configured to perform embodiments.

FIG. 3A illustrates an example of a cluster profile that specifies expected value constraints for attributes of alerts that belong to an associated cluster.

FIG. 3B illustrates an example of an explanation of why an alert has been classified into one of a plurality of groups.

FIG. 4 is a flow diagram of a method performed by the machine-learning platform to train a machine-learning model to cluster alerts, and to generate cluster profiles based on the clusters, according to an embodiment.

FIG. 5 is a flow diagram of a method performed by the machine-learning platform to process an alert based on an associated cluster profile of a statistically significant cluster, according to an embodiment.

FIG. 6 is a flow diagram of a method performed by the machine-learning platform to process an alert based on an associated cluster profile of a statistically insignificant cluster, according to an embodiment.

### DETAILED DESCRIPTION

Techniques for processing alerts for evaluation are described. Alerts are generated at endpoints of a customer environment. Some of those alerts are generated in response to malicious activity and are referred to herein as “malicious alerts.” Other alerts are generated in response to harmless activity and are referred to herein as “harmless alerts.” However, before those alerts are evaluated at a security analytics platform, the nature of the alerts is unknown.

According to embodiments, a machine-learning (ML) model is trained based on prior alerts received from the endpoints of the customer environment. The ML model is trained to divide the prior alerts into a plurality of clusters based on at least one attribute of the prior alerts. Then, as part of the ML, a profile is created for each of the clusters. Each cluster profile includes attributes and value constraints observed for all the prior alerts of the cluster. Later, each time a new alert is received from the customer environment, the new alert is determined to belong to one of the clusters, and the new alert is classified into one of a plurality of groups based on the associated cluster profile.

In some cases, actual values of the attributes for a new alert are compared to respective value constraints of the associated cluster profile. Deviations between the actual values of the attributes and respective value constraints of the cluster profile, result in the new alert being classified into a high-priority alert queue or gray alert queue to be prioritized by the security analytics platform for evaluation. Conversely, there being no deviations between the actual values of the attributes and respective value constraints of the cluster profile, results in the new alert being classified into a low-priority alert queue. In other cases, the size of the cluster that the new alert belongs to, is used to classify the new alert into a particular alert queue.

Embodiments are able to classify a large number of alerts for prioritizing evaluations thereof. Security agents of the customer environment may thus generate a large number of alerts that cover a wide range of malicious activity. Furthermore, the ML model is trained based on prior alerts of a particular organization. The cluster profiles used for classifying alerts are thus customized to the expected behavior of a particular organization and accordingly may be used for consistently prioritizing alerts that are likely malicious for the organization over alerts that are likely harmless for the organization. Finally, the cluster profiles include value constraints for several attributes for comparison to respective values for incoming alerts. Accordingly, embodiments are able to detect even slight deviations between the activity that generated new alerts and expected activity of the customer environment. Furthermore, value constraints for such a large number of attributes are difficult for attackers to learn and comply with, and even undermine an attacker's capabilities. These and further aspects of the invention are discussed below with respect to the drawings.

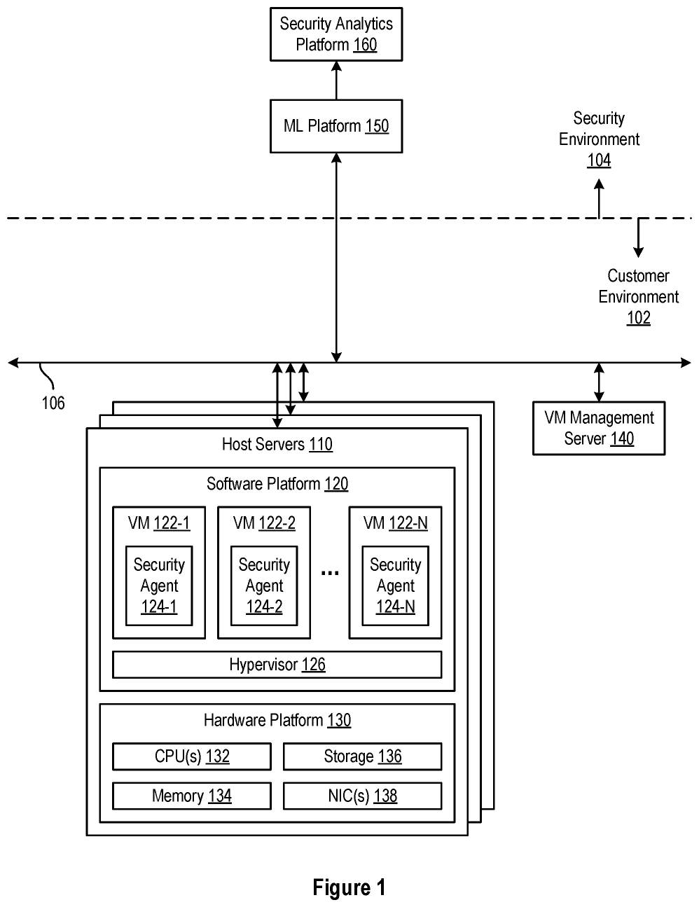

FIG. 1 is a block diagram of a virtualized computer system in which embodiments may be implemented. The virtualized computer system includes a customer environment 102 and an external security environment 104. As used herein, a “customer” is an organization that has subscribed to security services offered through an ML platform 150 of security environment 104. A “customer environment” is one or more private data centers managed by the customer (commonly referred to as “on-premise” data centers), a private cloud managed by the customer, a public cloud managed for the customer by another organization, or any combination of these. Although security environment 104 is illustrated as being external to customer environment 102, any components of security environment 104 may instead be implemented within customer environment 102.

Customer environment 102 includes a plurality of host servers 110 and a virtual machine (VM) management server 140. Each of host servers 110 is constructed on a server-grade hardware platform 130 such as an x86 architecture platform. Hardware platform 130 includes conventional components of a computing device, such as one or more central processing units (CPUs) 132, memory 134 such as random-access memory (RAM), local storage 136 such as one or more magnetic drives or solid-state drives (SSDs), and one or more network interface cards (NICs) 138. Local storage 136 of host servers 110 may optionally be aggregated and provisioned as a virtual storage area network (vSAN). NICs 138 enable host servers 110 to communicate with each other and with other devices over a physical network 106 such as a local area network.

Hardware platform 130 of each of host servers 110 supports a software platform 120. Software platform 120 includes a hypervisor 126, which is a virtualization software layer. Hypervisor 126 supports a VM execution space within which VMs 122 are concurrently instantiated and executed. One example of hypervisor 126 is a VMware ESX® hypervisor, available from VMware, Inc. VMs 122 include respective security agents 124, which generate alerts in response to suspicious activity. Although the disclosure is described with reference to VMs as endpoints of customer environment 102, the teachings herein also apply to nonvirtualized applications and to other types of virtual computing instances such as containers, Docker® containers, data compute nodes, and isolated user space instances for which behavior is monitored to discover malicious activities. Furthermore, although FIG. 1 illustrates VMs 122 and security agents 124 in software platform 120, the teachings herein also apply to security agents 124 implemented in firmware for hardware platform 130.

VM management server 140 logically groups host servers 110 into a cluster to perform cluster-level tasks such as provisioning and managing VMs 122 and migrating VMs 122 from one of host servers 110 to another. VM management server 140 communicates with host servers 110 via a management network (not shown) provisioned from network 106. VM management server 140 may be, e.g., a physical server or one of VMs 122. One example of VM management server 140 is VMware vCenter Server,® available from VMware, Inc.

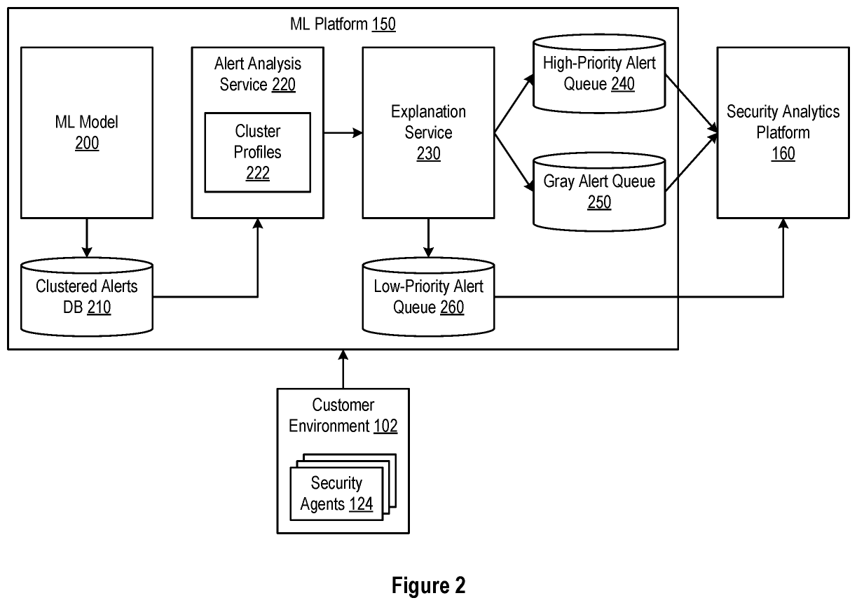

ML platform 150 provides security services to VMs 122. ML platform 150 communicates with VMs 122 over a public network (not shown), e.g., the Internet, to obtain alerts generated by security agents 124. Alternatively, if implemented within customer environment 102, ML platform 150 may communicate with VMs 122 over private networks, including network 106. ML platform 150 includes a variety of services for processing the alerts, as discussed further below in conjunction with FIG. 2. The services of ML platform 150 run in a VM or in one or more containers and are deployed on hardware infrastructure of a public computing system (not shown).

The hardware infrastructure supporting ML platform 150 includes the conventional components of a computing device discussed above with respect to hardware platform 130. CPU(s) of the hardware infrastructure are configured to execute instructions such as executable instructions that perform one or more operations described herein, which may be stored in memory of the hardware infrastructure. Upon receiving certain alerts generated at VMs 122, ML platform 150 transmits the alerts to a security analytics platform 160 for evaluation. For example, security analytics platform 160 may be an SOC at which SOC analysts use various security analytics tools to evaluate security alerts such as SIEM software or correlation engines.

FIG. 2 is a block diagram illustrating components of ML platform 150, which are configured to perform embodiments. Security agents 124 of customer environment 102 generate alerts based on suspicious activities and transmit those alerts to ML platform 150, e.g., over the Internet. During a training phase of ML platform 150, ML model 200 is trained to divide prior alerts from security agents 124 into clusters. ML model 200 then stores the clusters of prior alerts in a clustered alerts database (DB) 210. ML model 200 clusters the prior alerts based on at least one attribute of the prior alerts such as an initiator of activity that triggered the prior alerts.

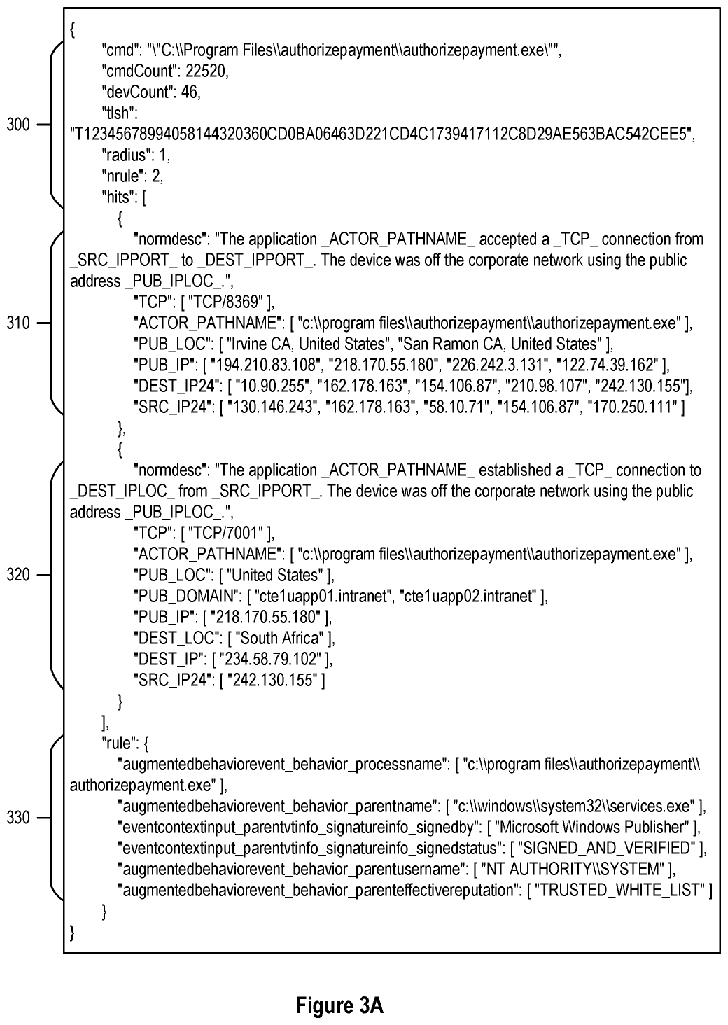

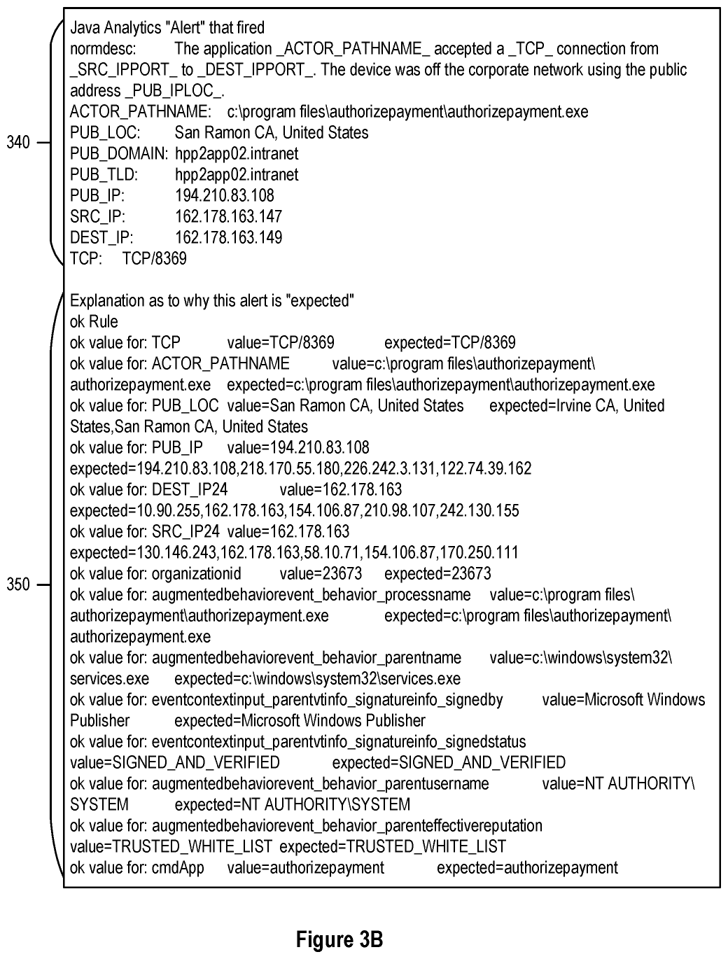

As part of the ML, for each of the clusters, ML platform 150 aggregates values of attributes of all the prior alerts of the cluster. ML platform 150 uses the aggregation of the values for each of the clusters to generate cluster profiles 222. Cluster profiles 222 of all the clusters are provided to an alert analysis service 220. Each of cluster profiles 222 is referred to herein simply as cluster profile 222. An example of cluster profile 222 is discussed below in conjunction with FIG. 3A.

During an operational phase of ML platform 150 (after the training phase), new alerts are received from security agents 124. When a new alert is determined to belong to a particular cluster of clustered alerts DB 210, alert analysis service 220 uses the associated cluster profile from cluster profiles 222 to determine how to process the new alert. An explanation service 230 then generates an explanation for the determined processing. The new alert and the explanation are then stored in a queue based on the determined processing.

For example, if a new alert is likely malicious, the new alert is classified into a high-priority group and stored in a high-priority alert queue 240 with its explanation. If the new alert is suspicious but not as likely to be malicious as alerts in the high-priority group, the new alert is classified into a gray group and stored in a gray alert queue 250 with its explanation. If the new alert is likely harmless, the new alert is classified into a low-priority alert queue 260 with its explanation.

ML platform 150 eventually dequeues alerts and explanations in high-priority alert queue 240 and gray alert queue 250 and transmits them to security analytics platform 160 for evaluation. Alerts and explanations in high-priority alert queue 240 are prioritized over those of gray alert queue 250. Alerts and explanations in low-priority alert queue 260 may later be transmitted to security analytics platform 160 on demand, e.g., upon malicious activity being detected and there potentially being evidence of the activity in alerts of the low-priority group. Although FIG. 2 illustrates three alert queues, embodiments may vary the number of alert queues used. For example, there may simply be two alert queues, one for high-priority alerts and another for low-priority alerts. There may also be more than three alert queues, thus creating more than three tiers of priority.

FIG. 3A illustrates an example of cluster profile 222, represented in JavaScript Object Notation (JSON) format. Lines 300 of cluster profile 222 include attributes of the associated cluster. As indicated by the value of the “cmd” attribute of lines 300, every prior alert of the cluster executed a command that was similar (if not identical) to the following command: “C:\Program Files\authorizepayment\authorizepayment.exe.” As indicated by the value of the “cmdCount” attribute of lines 300, the size of the cluster is 22,520, i.e., there are 22,520 prior alerts in the cluster. The larger “cmdCount” is, the more statistically significant the cluster is, i.e., the more common it was during the training phase for the prior alerts to be assigned to the cluster. The statistical significance of a cluster affects how cluster profile 222 is applied during the operational phase, as discussed further below.

The value of the “tlsh” (trend locality sensitive hash) attribute of lines 300 is a hash of the values of any attributes that were used for clustering the prior alerts. In the example of FIG. 3A, the “cmd” attribute was used for clustering the prior alerts, and the value of the “tlsh” attribute is thus a hash of the value of the “cmd” attribute. The “tlsh” attribute is used to determine whether a new alert belongs to particular cluster. Specifically, a command indicated by the new alert is hashed and compared to the value of the “tlsh” attribute. If the distance is within a threshold indicated by the value of the “radius” attribute, then the new alert belongs to the cluster. It should be noted that applying trend locality sensitive hashes (TLSHs) is merely one method of clustering alerts. Other known methods in the art may alternatively be used.

Cluster profile 222 includes a number “nrule” of rules associated with the cluster. The rules associated with a cluster include all the rules that triggered prior alerts of the cluster, such rules being used by security agents 124 for identifying malicious activity. Cluster profile 222 illustrated by FIG. 3A includes two such rules, one represented in lines 310 and another represented in lines 320. However, the number of rules that may trigger prior alerts of a cluster may be only one or may be much greater.

The first rule, represented in lines 310, is triggered by one of VMs 122 accepting an inbound transmission control protocol (TCP) connection. Lines 310 include a plurality of attributes of prior alerts that triggered the first rule, including “TCP,” “ACTOR_PATHNAME,” etc. Every prior alert of the cluster that triggered the first rule had values matching one of those indicated by the expected value constraints of lines 310. For example, each such prior alert had a value “TCP/8369” for the “TCP” attribute, and each prior alert had either a value “Irvine CA, United States” or a value “San Ramon CA, United States” for a “PUB_LOC” attribute. Additionally, some of the expected value constraints of lines 310 are derived. For example, prior alerts may have included destination IP addresses such as 10.90.255.1, 10.90.255.2, etc. Instead of including each such IP address in lines 310, ML platform 150 derived the net block 10.90.255 and determined that any IP addresses from that net block are expected destination IP addresses for the organization. In lines 310, ML platform 150 thus added the value “10.90.255” to lines 310 as part of an expected value constraint for a “DEST_IP24” attribute.

The second rule, represented in lines 320, is triggered by one of VMs 122 establishing an outbound TCP connection. Lines 320 include a plurality of attributes of prior alerts that triggered the second rule, including “TCP,” “ACTOR_PATHNAME,” etc. Every prior alert of the cluster that triggered the second rule had values matching one of those indicated by the expected value constraints of lines 320. For example, each such prior alert had a source IP address within the net block “242.130.155,” as indicated by the derived value of an “SRC_IP24” attribute.

Lines 330 include additional attributes common to all the prior alerts of the cluster, including those that were triggered by the first rule and those that were triggered by the second rule. Those additional attributes include “augmentedbehaviorevent_behavior_processname,” “augmentedbehaviorevent_behavior_parentname,” etc. For example, every prior alert of the cluster had a value “c:\program files\authorizepayment\authorizepayment.exe” for the “augmentedbehaviorevent_behavior_processname” attribute.

It should be noted that FIG. 3A only illustrates certain types of expected value constraints such as expected values, lists of expected values, and expected IP ranges. Other types of expected value constraints may also be added to cluster profiles according to embodiments. For example, regular expressions that express patterns may be used as expected value constraints for various attributes. As another example, numerical ranges such as “>2” may be used as expected value constraints for various attributes.

As mentioned earlier, the size of the cluster is 22,520. If that value is greater than a predetermined threshold, then the cluster is considered to be statistically significant. In such case, when a new alert is determined to belong to the cluster, values of attributes for the new alert are compared to value constraints for respective attributes of cluster profile 222 to determine how to process the new alert. For example, if the new alert was triggered by the first rule, attributes for the new alert are compared to every attribute of lines 310 and 330. Otherwise, if the new alert was triggered by the second rule, attributes for the new alert are compared to every attribute of lines 320 and 330. Any deviations result in classification into one of the high-priority and gray groups, while there being no deviations results in classification into the low-priority group.

On the other hand, if 22,520 is less than the predetermined threshold, then the cluster is considered to be statistically insignificant. In such case, when a new alert is determined to belong to the cluster, the new alert is classified into one of the high-priority and gray groups regardless of the values of attributes for the new alert. This is because prior alerts that were similar to the new alert were relatively rare during training. Accordingly, the new alert should be prioritized for evaluation at security analytics platform 160.

FIG. 3B illustrates an example of an explanation of why a new alert has been classified into the low-priority group. The explanation of FIG. 3B is related to a new alert that was determined to belong to the cluster associated with cluster profile 222 of FIG. 3A. Additionally, for purposes of discussion of FIG. 3B, the cluster is deemed to be statistically significant. Lines 340 include a description of the new alert. As indicated by the value of a “normdesc” attribute of lines 340, the new alert was triggered by one of VMs 122 accepting an inbound TCP connection. The remaining attributes of lines 340 include an “ACTOR_PATHNAME” attribute, a “PUB_LOC” attribute, etc. The values of each of these attributes are values for the new alert.

Lines 350 begin by indicating that the new alert is “expected,” i.e., likely harmless. Lines 350 also include comparisons between the attributes for the new alert and relevant attributes of cluster profile 222. Lines 350 include comparisons to attributes that are specific to the rule that triggered the alert, i.e., the rule that one of VMs 122 satisfied to trigger the alert. For example, according to lines 350, the value of the attribute “TCP” for the new alert is “TCP/8369,” which is what is expected according to cluster profile 222.

Furthermore, lines 350 include comparisons to attributes of all alerts of the cluster regardless of which rule triggered the alert. For example, according to lines 350, the value of the attribute “augmentedbehaviorevent_behavior_processname” is “c:\program files\authorizepayment\authorizepayment.exe,” which is what is expected according to cluster profile 222. Because the cluster is statistically significant and every value for the new alert matches what is expected, the alert was generated based on behavior that is expected from customer environment 102 according to the prior alerts from the training phase.

According to embodiments, there are many attributes that a new alert must match to avoid being classified into the high-priority or gray group. It is thus difficult for an attacker to comply with the expected behavior of VMs 122 without the malicious activity being detected quickly. Even a slight deviation between the attacker's behavior and common behavior of VMs 122 is quickly discovered. This is because even a slight deviation in behavior may result in a deviation between an attribute for the malicious alert and a respective attribute of cluster profile 222. Furthermore, even if the attacker knows the attributes and expected value constraints to comply with, the expected value constraints undermine the attacker's capabilities. The more attributes there are to match, the more limited the attacker's behavior is for the attacker to avoid triggering a new alert that is classified into the high-priority or gray groups. For example, the attacker may be limited to accepting or establishing TCP connections with only certain ports.

The explanation of FIG. 3B includes many specific details about a new alert and about cluster profile 222. Such specific details simplify the process of evaluating the alert for an SOC analyst at security analytics platform 160. However, in certain cases, it may be more secure to generate a generic explanation. For example, if an attacker obtains an explanation from security analytics platform 160, then it is preferable for the explanation to not have explained every aspect of the alert's classification. Hiding certain details prevents the attacker from learning exactly how to conduct malicious activities in an inconspicuous manner. As one example, a generic explanation may only specify attributes that are checked without specifying their expected value constraints. As another example, a generic explanation may only specify a portion of constraints such as specifying countries without specifying cities therein.

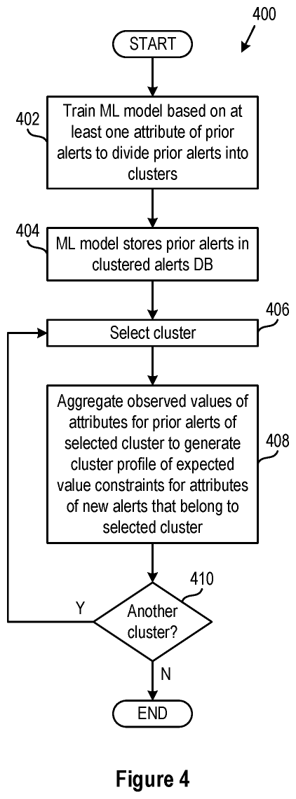

FIG. 4 is a flow diagram of a method 400 performed by ML platform 150 to use ML to train ML model 200 based on prior alerts collected during a training period and generate cluster profiles 222, according to an embodiment. Method 400 is performed during the training phase. At step 402, ML platform 150 trains ML model 200 based on at least one attribute of the prior alerts to divide the prior alerts into clusters. For example, the at least one attribute may comprise an initiator of activity that triggered the prior alerts. For example, such an initiator may be a command entered into an administrative tool such as PowerShell,® creation of a process, or scheduling of a task.

At step 404, ML model 150 stores the prior alerts in clustered alerts DB 210. At step 406. ML platform 150 selects a cluster from clustered alerts DB 210. At step 408, ML platform 150 aggregates observed values of attributes for all the prior alerts of the cluster to generate associated cluster profile 222. Cluster profile 222 includes such observed values as expected value constraints for the attributes of new alerts that are later determined to belong to the cluster. Cluster profile 222 is provided to alert analysis service 220. At step 410, if there is another cluster that has not yet been selected, method 400 returns to step 406, and ML model 150 selects another cluster. Otherwise, at step 410, if cluster profiles 222 have been created for every cluster of clustered alerts DB 210, method 400 ends.

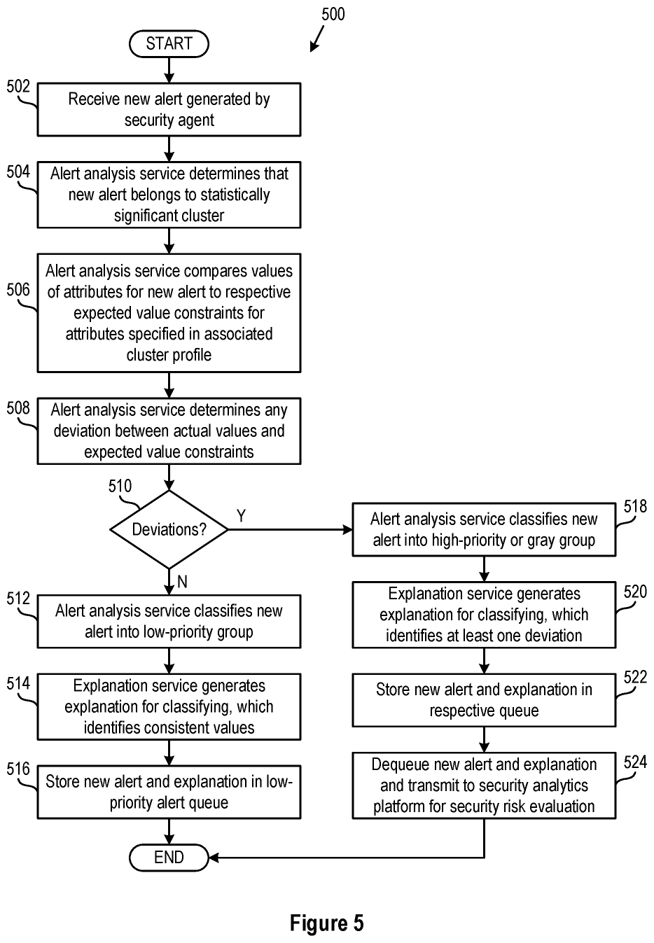

FIG. 5 is a flow diagram of a method 500 performed by ML platform 150 to process an alert based on associated cluster profile 222 of a statistically significant cluster, according to an embodiment. Method 500 is performed during the operational phase, after ML model 200 has been trained and cluster profiles 222 have been generated and provided to alert analysis service 220. At step 502, ML platform 150 receives a new alert generated by one of security agents 124. At step 504, alert analysis service 220 checks cluster profiles 222 to determine that the new alert belongs to a statistically significant cluster. Such a cluster has a size that is greater than a predetermined threshold, i.e., includes a number of prior alerts that is greater than the threshold. For example, in the case of cluster profile 222 of FIG. 3A, alert analysis service 220 hashes a value of an attribute for the new alert and determines that the hash is within a threshold distance from a value of a “tlsh” attribute of cluster profile 222.

At step 506, alert analysis service 220 compares values of attributes for the new alert (actual values) to respective value constraints for attributes specified in cluster profile 222 (expected value constraints). Some of the attributes only correspond to a particular rule that triggered the alert. Other attributes correspond to all the prior alerts of cluster profile 222. At step 508, alert analysis service 220 determines any deviation between the actual values and the expected value constraints.

At step 510, if there are no deviations, method 500 moves to step 512. At step 512, alert analysis service 220 classifies the new alert into the low-priority group. At step 514, explanation service 230 generates an explanation for the classifying of step 512. The explanation identifies the consistency between the actual values and the expected value constraints. As discussed earlier, such an explanation may include all the actual values and expected value constraints or may be generic. After step 516, method 500 ends. Returning to step 510, if there is at least one deviation between an actual value and an expected value constraint, method 500 moves to step 518.

At step 518, alert analysis service 220 classifies the new alert into either the high-priority or gray group. The selection between the high-priority or gray group is predetermined by an administrator of ML platform 150 based on a variety of factors. At step 520, explanation service 230 generates an explanation for the classifying of step 518. Such an explanation may include all the actual values and expected value constraints or may be generic. At step 522, ML platform 150 stores the new alert and explanation in the respective queue, i.e., in high-priority alert queue 240 if classified into the high-priority group or in gray alert queue 250 if classified into the gray group.

At step 524, ML platform 150 dequeues the new alert and explanation and transmits them to security analytics platform 160 for security risk evaluation. At security analytics platform 160, the new alert is evaluated for malicious activity of the computer system, i.e., it is determined whether the new alert is a malicious alert or a harmless alert. ML platform 150 dequeues the new alert based on its priority relative to other alerts. Alerts are dequeued more quickly from high-priority alert queue 240 than from gray alert queue 250. If the new alert is a malicious alert, security analytics platform 160 quickly identifies the associated malicious activity and remediates customer environment 102 accordingly. After step 524, method 500 ends.

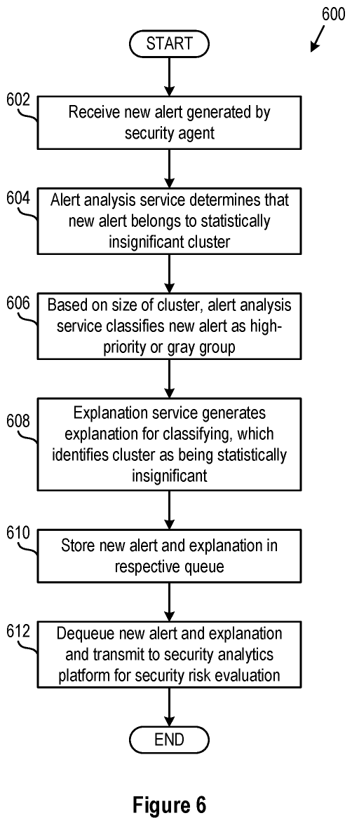

FIG. 6 is a flow diagram of a method 600 performed by ML platform 150 to process an alert based associated cluster profile 222 of a statistically insignificant cluster, according to an embodiment. Method 600 is performed during the operational phase, after ML model 200 has been trained and cluster profiles 222 have been generated and provided to alert analysis service 220. At step 602, ML platform 150 receives a new alert generated by one of security agents 124.

At step 604, alert analysis service 220 checks cluster profiles 222 to determine that the new alert belongs to a statistically insignificant cluster. Such a cluster has a size that is less than a predetermined threshold, i.e., includes a number of prior alerts that is less than the threshold. For example, in the case of cluster profile 222 of FIG. 3A, alert analysis service 220 hashes a value of an attribute for the new alert and determines that the hash is within a threshold distance from a value of a “tlsh” attribute of cluster profile 222.

At step 606, based on the size of the cluster, alert analysis service 220 classifies the new alert into either the high-priority or gray group. The selection between the high-priority or gray group is predetermined by the administrator of ML platform 150 based on a variety of factors. For example, the administrator may determine that a new alert that belongs to a statistically insignificant cluster is always classified into the gray group. At step 608, explanation service 230 generates an explanation for the classifying of step 606. The explanation indicates that the new alert belongs to a statistically insignificant cluster, e.g., reciting that alerts like the new alert are relatively rare for the organization of customer environment 102.

At step 610, ML platform 150 stores the new alert and explanation in the respective queue, i.e., in high-priority alert queue 240 if classified into the high-priority group or in gray alert queue 250 if classified into the gray group. At step 612, ML platform 150 dequeues the new alert and explanation and transmits them to security analytics platform 160 for security risk evaluation. At security analytics platform 160, the new alert is evaluated for malicious activity of the computer system, i.e., it is determined whether the new alert is a malicious alert or a harmless alert. ML platform 150 dequeues the new alert based on its priority relative to other alerts. If the new alert is a malicious alert, security analytics platform 160 quickly identifies the associated malicious activity and remediates customer environment 102 accordingly. After step 612, method 600 ends.

Beyond the above descriptions of methods 500 and 600, there is a variety of additional reasons why embodiments may classify alerts into the high-priority or gray groups. For example, in certain cases, alert analysis service 220 may determine that a new alert does not belong to any of the clusters of clustered alerts DB 210. In such a case, if TLSHs are applied for clustering alerts, the hash of a value of an attribute for the new alert is not within a threshold distance from the value of the “tlsh” attribute of any of cluster profiles 222. Alert analysis service 220 classifies such alerts into the high-priority group. As another example, alert analysis service 220 may determine that a new alert belongs to a cluster but was generated by a different rule than those of the associated cluster profile. Alert analysis service 220 classifies such alerts into the high-priority group.

As another example, a new alert may be of a particular type that warrants classification into a particular group. If the new alert is of a “prevention” type, then the type indicates that in addition to generating the new alert, one of security agents 124 also initiated one or more preventative actions such as blocking or terminating a process and quarantining a file. Alert analysis service 220 classifies such an alert into the high-priority group. As another example, a cluster may include a prior alert that was determined at security analytics platform 160 to be malicious. As a result, alert analysis service 220 may classify any new alerts belonging to the same cluster into the gray group.

The administrator of ML platform 150 may also decide to mark an entire cluster as being high priority or as being gray. For example, the administrator may know that usage of a particular program is typically harmless but occasionally dangerous. If there is a cluster that includes prior alerts that were generated in response to usage of the program, the administrator may mark the cluster as gray. Any new alerts that belong to the cluster are then classified into the gray group. As another example, the administrator may know that every alert of a cluster has been malicious and may thus mark the cluster as high priority. Any new alerts that belong to the cluster are then classified into the high-priority group.

The embodiments described herein may employ various computer-implemented operations involving data stored in computer systems. For example, these operations may require physical manipulation of physical quantities. Usually, though not necessarily, these quantities are electrical or magnetic signals that can be stored, transferred, combined, compared, or otherwise manipulated. Such manipulations are often referred to in terms such as producing, identifying, determining, or comparing. Any operations described herein that form part of one or more embodiments may be useful machine operations.

One or more embodiments of the invention also relate to a device or an apparatus for performing these operations. The apparatus may be specially constructed for required purposes, or the apparatus may be a general-purpose computer selectively activated or configured by a computer program stored in the computer. Various general-purpose machines may be used with computer programs written in accordance with the teachings herein, or it may be more convenient to construct a more specialized apparatus to perform the required operations. The embodiments described herein may also be practiced with computer system configurations including hand-held devices, microprocessor systems, microprocessor-based or programmable consumer electronics, minicomputers, mainframe computers, etc.

One or more embodiments of the present invention may be implemented as one or more computer programs or as one or more computer program modules embodied in computer-readable media. The term computer-readable medium refers to any data storage device that can store data that can thereafter be input into a computer system. Computer-readable media may be based on any existing or subsequently developed technology that embodies computer programs in a manner that enables a computer to read the programs. Examples of computer-readable media are magnetic drives, SSDs, network-attached storage (NAS) systems, read-only memory (ROM), RAM, compact disks (CDs), digital versatile disks (DVDs), magnetic tapes, and other optical and non-optical data storage devices. A computer-readable medium can also be distributed over a network-coupled computer system so that computer-readable code is stored and executed in a distributed fashion.

Although one or more embodiments of the present invention have been described in some detail for clarity of understanding, certain changes may be made within the scope of the claims. Accordingly, the described embodiments are to be considered as illustrative and not restrictive, and the scope of the claims is not to be limited to details given herein but may be modified within the scope and equivalents of the claims. In the claims, elements and steps do not imply any particular order of operation unless explicitly stated in the claims.

Virtualized systems in accordance with the various embodiments may be implemented as hosted embodiments, non-hosted embodiments, or as embodiments that blur distinctions between the two. Furthermore, various virtualization operations may be wholly or partially implemented in hardware. For example, a hardware implementation may employ a look-up table for modification of storage access requests to secure non-disk data. Many variations, additions, and improvements are possible, regardless of the degree of virtualization. The virtualization software can therefore include components of a host server, console, or guest operating system (OS) that perform virtualization functions.

Boundaries between components, operations, and data stores are somewhat arbitrary, and particular operations are illustrated in the context of specific illustrative configurations. Other allocations of functionality are envisioned and may fall within the scope of the invention. In general, structures and functionalities presented as separate components in exemplary configurations may be implemented as a combined component. Similarly, structures and functionalities presented as a single component may be implemented as separate components. These and other variations, additions, and improvements may fall within the scope of the appended claims.

What is claimed is:

1. A computer system comprising:
a plurality of endpoints at which security agents generate alerts; and
a machine-learning (ML) platform at which prior alerts are received from the endpoints during a training period and divided into a plurality of clusters, wherein each of the clusters has an associated cluster profile that specifies expected value constraints for attributes of new alerts that are determined to belong to the cluster, and wherein the ML platform is configured to execute on a processor of a hardware platform to:
receive a first alert generated by one of the security agents, and then determine that the first alert belongs to a first cluster of the clusters, wherein a number of prior alerts in the first cluster is greater than a threshold;
based on the number of prior alerts in the first cluster being greater than the threshold, compare actual values of the attributes for the first alert to respective expected value constraints for the attributes specified in the cluster profile of the first cluster;
determine any deviation between the actual values of the attributes and the respective expected value constraints for the attributes; and
classify the first alert into one of a plurality of alert groups based on whether there is any deviation, wherein alerts classified into a first alert group of the alert groups are assigned a higher priority for security risk evaluation than alerts classified into a second alert group of the alert groups.

2. The computer system of claim 1, wherein based on there being at least one deviation between the actual values of the attributes and the respective expected value constraints for the attributes, the first alert is classified into the first alert group, and the ML platform is further configured to:
transmit the first alert to a security analytics platform for security risk evaluation.

3. The computer system of claim 2, wherein the ML platform is further configured to:
generate an explanation for the classifying of the first alert, wherein the explanation identifies the at least one deviation; and
transmit the explanation to the security analytics platform along with the first alert.

4. The computer system of claim 1, wherein based on there being no deviation, the first alert is classified into the second alert group.

5. The computer system of claim 1, wherein the ML platform is further configured to:
receive a second alert generated by one of the security agents, and then determine that the second alert belongs to a second cluster of the clusters; and
classify the second alert into the first alert group based on a size of the second cluster being less than a threshold.

6. The computer system of claim 1, wherein the ML platform is further configured to:
before receiving the first alert, train an ML model based on an attribute of the prior alerts to divide the prior alerts into the clusters, wherein for each of the clusters, the expected value constraints for the attributes specified by the associated cluster profile indicate values observed from the prior alerts of the cluster, wherein the attribute of the prior alerts based on which the ML model is trained is an initiator of activities that triggered the prior alerts, and for each of the prior alerts, the initiator is one of: a command entered into an administrative tool, creation of a process, and scheduling of a task.

7. A method of processing alerts generated by security agents installed at endpoints of a computer system, wherein a plurality of prior alerts collected during a training period are divided into a plurality of clusters, and each of the clusters has an associated cluster profile that specifies expected value constraints for attributes of new alerts that are determined to belong to the cluster, the method comprising:
receiving a first alert generated by one of the security agents, and then determining that the first alert belongs to a first cluster of the clusters;
comparing actual values of the attributes for the first alert to respective expected value constraints for the attributes specified in the cluster profile of the first cluster;
determining any deviation between the actual values of the attributes and the respective expected value constraints for the attributes; and
classifying the first alert into one of a plurality of alert groups based on whether there is any deviation, wherein alerts classified into a first alert group of the alert groups are assigned a higher priority for security risk evaluation than alerts classified into a second alert group of the alert groups.

8. The method of claim 7, wherein based on there being at least one deviation between the actual values of the attributes and the respective expected value constraints for the attributes, the first alert is classified into the first alert group, the method further comprising:
transmitting the first alert to a security analytics platform for security risk evaluation.

9. The method of claim 8, further comprising:
generating an explanation for the classifying of the first alert, wherein the explanation identifies the at least one deviation; and
transmitting the explanation to the security analytics platform along with the first alert.

10. The method of claim 7, wherein based on there being no deviation, the first alert is classified into the second alert group.

11. The method of claim 7, further comprising:
receiving a second alert generated by one of the security agents, and then determining that the second alert belongs to a second cluster of the clusters; and
classifying the second alert into the first alert group based on a size of the second cluster being less than a threshold.

12. The method of claim 7, further comprising:
before receiving the first alert, training a machine-learning model based on an attribute of the prior alerts to divide the prior alerts into the clusters, wherein for each of the clusters, the expected value constraints for the attributes specified by the associated cluster profile indicate values observed from the prior alerts of the cluster.

13. The method of claim 12, wherein the attribute of the prior alerts based on which the machine-learning model is trained is an initiator of activities that triggered the prior alerts, and for each of the prior alerts, the initiator is one of: a command entered into an administrative tool, creation of a process, and scheduling of a task.

14. A non-transitory computer-readable medium comprising instructions that are executable in a computer system, wherein the instructions when executed cause the computer system to carry out a method of processing alerts generated by security agents installed at endpoints, a plurality of prior alerts collected during a training period being divided into a plurality of clusters, and each of the clusters having an associated cluster profile that specifies expected value constraints for attributes of new alerts that are determined to belong to the cluster, the method comprising:
receiving a first alert generated by one of the security agents, and then determining that the first alert belongs to a first cluster of the clusters;
comparing actual values of the attributes for the first alert to respective expected value constraints for the attributes specified in the cluster profile of the first cluster, wherein the cluster profile of the first cluster includes a plurality of rules that triggered prior alerts of the first cluster, and a plurality of the respective expected value constraints are only associated with one of the rules and not with the other rules;
determining any deviation between the actual values of the attributes and the respective expected value constraints for the attributes; and
classifying the first alert into one of a plurality of alert groups based on whether there is any deviation, wherein alerts classified into a first alert group of the alert groups are assigned a higher priority for security risk evaluation than alerts classified into a second alert group of the alert groups.

15. The non-transitory computer-readable medium of claim 14, wherein based on there being at least one deviation between the actual values of the attributes and the respective expected value constraints for the attributes, the first alert is classified into the first alert group, the method further comprising:
transmitting the first alert to a security analytics platform for security risk evaluation.

16. The non-transitory computer-readable medium of claim 15, the method further comprising:
generating an explanation for the classifying of the first alert, wherein the explanation identifies the at least one deviation; and
transmitting the explanation to the security analytics platform along with the first alert.

17. The non-transitory computer-readable medium of claim 14, wherein based on there being no deviation, the first alert is classified into the second alert group.

18. The non-transitory computer-readable medium of claim 14, the method further comprising:
receiving a second alert generated by one of the security agents, and then determining that the second alert belongs to a second cluster of the clusters; and
classifying the second alert into the first alert group based on a size of the second cluster being less than a threshold.

19. The non-transitory computer-readable medium of claim 14, the method further comprising:
before receiving the first alert, training a machine-learning model based on an attribute of the prior alerts to divide the prior alerts into the clusters, wherein for each of the clusters, the expected value constraints for the attributes specified by the associated cluster profile indicate values observed from the prior alerts of the cluster.

20. The non-transitory computer-readable medium of claim 19, wherein the attribute of the prior alerts based on which the machine-learning model is trained is an initiator of activities that triggered the prior alerts, and for each of the prior alerts, the initiator is one of: a command entered into an administrative tool, creation of a process, and scheduling of a task.
